(19) United States
(12) Patent Application Publication
(10) Pub. No.: US 2004/0002900 A1
(43) Pub. Date: Jan. 1, 2004

(54) Method and system for providing greater value in electronic order processing

(75) Inventors: Richard Cohen, Wilkes-Barre, PA (US); Charles Cohen, Waverly, PA (US); Eric Labashosky, Scotrun, PA (US)

Correspondence Address: MITCHELL A. SMOLOW, 720 HAMPTON ROAD, SHAVERTOWN, PA, 18708, US

(73) Assignee: Milford Holding Co., Highland Beach, FL

(21) Appl. No.: 10/186,020

(22) Filed: Jun. 28, 2002

(51) Int. Cl. G06F 17/60

(52) U.S. Cl. 705/26; 705/14

(57) ABSTRACT

The present invention provides a system and method for presenting a user with a substitute product of greater value while maintaining equal or better quality. When a user places an order for an item, the system alerts the user if a better Value Item is available. The information presented by the system may include the Value Item product number, manufacturer, description, and a reason or explanation as to why the item is a better value. The system then permits the user to accept or reject the Value Item while alerting the user as to the total savings achieved. The system does not rely on third parties for maintenance and access to required data.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure, as it appears in the Patent and Trademark Office patent files or records, but otherwise reserves all copyright and trade dress rights whatsoever.

### FIELD OF THE INVENTION

This invention relates generally to effecting commercial transactions over communication networks and in particular, to the electronic offering and selection of products of equivalent or greater quality, thereby producing better value for the customer.

### BACKGROUND OF THE INVENTION

The term “electronic commerce” has become associated with remote commerce wherein at least a portion of the customer-to-seller contact is in electronic form. For example, a remotely located customer may utilize a private network such as a dedicated telephone line to access a seller's database, or alternatively, electronic commerce may be conducted on a publicly available electronic communication network, for example, the Internet.

Various methods of conducting electronic commerce have been well documented. For example, U.S. Pat. No. 6,119,094 to Lynch, et al. is directed to an automated system for identifying alternate localized travel arrangements. The system obtains inventory information specifying a rate and/or availability of a plurality of travel arrangements from one or more computer reservation systems. The inventory information is stored in a database along with one or more portfolios of information (relating to a travel agency and each business entity customer of the travel agency) that can be used to discount the listed rates of the travel arrangements. In response to travel request information received from a customer, the system automatically retrieves the inventory and/or discount information from the database and determines a plurality of low-cost alternative travel arrangements that are available to the customer.

While the Lynch et al. patent discloses a method for providing alternative lower cost products, it is dependant upon at least one remote third party database to provide inventory information.

U.S. Pat. No. 6,035,288 to Solomon provides a system for selling merchandise and/or services that a customer can purchase for a negotiable price. An algorithm representing behavioral activities of a simulated merchant is used to receive customer input data relating to particular goods and/or services designed to be purchased. This customer input data is processed to generate merchant responses to the customer input data, and the sales of goods and/or services are agreed to at a particular price as a result of processing of customer replies to merchant responses according to the algorithm.

U.S. Pat. No. 6,129,274 to Suzuki is directed to an electronic personal shopping system for communicating between a customer's personal database and point of sale terminals in a retail facility. Demographic profile data, a customer's transaction history data, and a customer's current incentive indicia are stored in predetermined locations in a memory of a portable machine smartcard. A customer assistance or kiosk terminal is able to develop promotional and personalized greeting methods used by reading and analyzing the demographic profile, transaction history, and the incentive indicia information stored in the smartcard to personalize the service offered to each individual customer.

U.S. Pat. No. 6,119,099 to Walker, et at.; U.S. Pat. No. 6,223,163 B1 to Van Luchene; and U.S. Pat. No. 6,196,458 B1 to Walker, et al. are all directed to merchant specified upsell offer conditions. As defined in these patents, and upsell is a product, for example, a good or a service, which is offered along with a purchase and has a value approximately equal to a predetermined upsell price. These upsells are offered in lieu of the customer's change due at time of sale, thereby providing additional revenue per upsell, and avoiding the exchange of monies as change.

U.S. Pat. No. 6,055,513 to Katz, et al. is also directed to a merchant upsell offer condition. The upsell offer may be made as an additional offer, or in lieu of the primary transaction. This patent defines an upsell as a product or service offered which differs materially from the product or service for which the contact was made. A second customer data element is used with the primary transaction to determine the upsell offer.

While all of the above referenced systems do provide some benefit to the consumer, they have limitations. Upsell methods primarily benefit the seller, in that the customer is incentivized to purchase additional items, thereby spending more than the customer originally planned. For many customers, upon reflecting on their additional unintended purchase, goodwill towards the seller may be lost. Those systems that offer customers items of equal value at lower cost require, and are dependent upon, third party databases. If the third party database becomes inaccessible, or is poorly maintained by the third party, the seller loses the ability to service its customers.

Accordingly it would be desirable to provide a system that will allow a seller to offer its customers substitute items of equal or higher quality at greater value, thereby creating goodwill and increasing overall sales, without having to access an outside third party database. The present invention fulfills this need, and further provides related advantages.

### BRIEF SUMMARY OF THE INVENTION

The present invention provides a system and method for presenting a user with a substitute product of greater value while maintaining equal or better quality.

When a user places an order for an item, the system alerts the user if a better Value Item is available. The information presented by the system may include the Value Item product number, manufacturer, description, and a reason or explanation as to why the item is a better value. The system then permits the user to accept or reject the Value Item while alerting the user as to the total savings achieved.

One advantage of the present invention is that the system does not have to rely upon third party databases upon which the seller has little or no control. Because pricing and other sales information is self-contained within a proprietary seller maintained database, downtime and inconvenience due to third party data corruption is avoided.

Another advantage of the present invention is the ability to allow a user to set the criteria on which item substitution is based and to affirmatively opt out of certain predefined criteria.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIGS. 1a-1c are a flow chart demonstrating simplified aspects of the present invention.

FIG. 2 is a block diagram of the categorization of Value Items within Product Groups.

FIG. 3 is a block diagram of the client database/server database relationship.

FIG. 4 is a screen shot of a representative Product Group listing.

FIG. 5 is a screen shot of a representative Value Item pop up window.

FIG. 6 is a screen shot of a representative Value Item substitution confirmation pop up window.

### DETAILED DESCRIPTION OF THE INVENTION

Although the preferred embodiment is directed to sales from a distributor to a customer, it should be understood that this is an exemplar only, and that the various structures and functionalities may be extended to other sales implementations.

As used herein, the term “user” refers to anyone seeking to take advantage of the substitute product information provided by the method and system of the present invention and may include, for example, a customer, an employee of a seller, or a sales representative of the seller. A “Value Item” is a product designated by the seller as being the best value when compared to materially similar products. “Materially similar” means a product that performs substantially the same function or is substantially the same in appearance, delivered in substantially the same quantity as the “ordered” (originally requested) product. A “Displayed Value Item” is a Value Item which the user has indicated can be substituted for the Ordered Item.

As used herein, the phrase “the system determines” or phrases similar thereto when used in the context of receiving user input, is meant to signify the system prompts the user for a response, and determines the result of any such response.

Various descriptions of the structure and function of the preferred embodiments are described below. However, as is understood by those skilled in the art, the performance of a given functionality may be distributed among one or more components, and conversely, multiple structures may be required to achieve a desired functionality. While the detailed descriptions herein have been provided with respect to certain allocations of functionalities and structure to various items (such as elements of a block diagram or flowchart) the underlying inventions herein should not be limited to the allocation of those structures, functions, diagrammatic representations or labeling selected for expository convenience herein. Accordingly, the understanding of the inventions herein should be based upon the functionalities, as implemented by selected structures, though not necessarily upon the particular unit of structure in which the functionalities resides.

In a preferred embodiment, the system resides locally, and is directly accessible by the user via a local input/output device such as a keyboard, keypad, or mouse connected to, for example, a user's personal computer running a personal computer operating system such as a Windows, Linux or MacIntosh operating system.

Optionally, the system resides remotely, and is indirectly accessible by the user, for example, located on a remote networked personal computer or a remote mainframe computer, such as an IBM mainframe computer. When residing remotely, the user accesses the system via a local input/output device such as a keyboard, keypad, or mouse connected to, for example, a terminal, a personal computer, a laptop computer, a cell phone or other handheld device containing a visual display connected through, for example, a telephone connection or the worldwide web utilizing a web browser such as Internet Explorer or Netscape Navigator. Such connection may be made via any standard connecting interface, such as a modem, DSL modem or cable modem.

In a first preferred embodiment, the system resides locally. As used herein, residing locally means that after linking with the server database, as described below, all functions are performed on the user's microprocessor, for example, the user's personal computer.

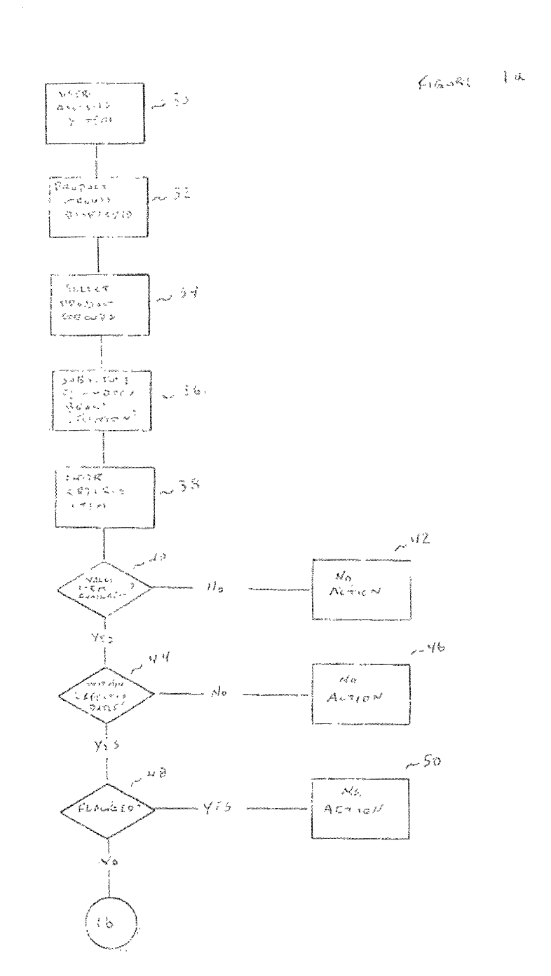

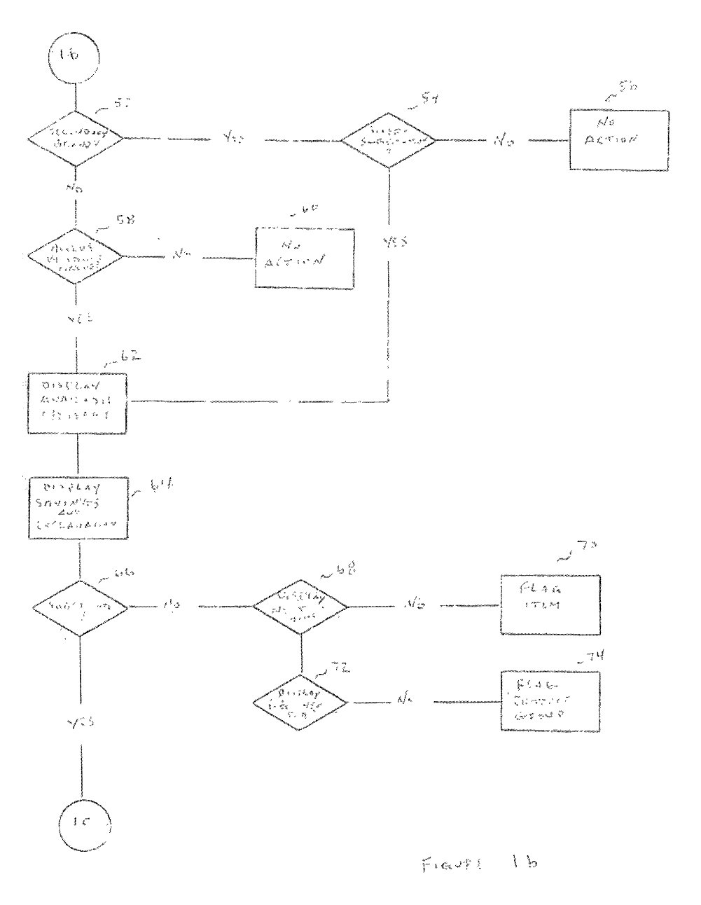

Referring to FIGS. 1a, 1b, and 1c, initially, a user accesses the system 30. Once a user has accessed the system 30, the system presents to the user preselected Product Groups 32, described in greater detail below. The Product Groups are presented through, for example, preferably a pull down menu selection, or alternatively, via a pop-up menu or a separate screen. Referring to FIG. 4, the user is prompted to choose the Product Groups for which the user would like the system to present better value alternatives 34, i.e. Value Items. Returning to FIGS. 1a-1c, optionally, the system permits the user to also indicate whether the user would like to see substitution of a Value Item for an ordered product where the only difference is the brand name 36, that is where the Ordered Item and the Value Item are substantially identical and manufactured by the same manufacturer but packaged under different brand names, for example, for different vendors. Manufactures often refer to these as “secondary” brands, and will be referred to as such herein.

After receiving input from the user indicating to the system the item the user wishes to purchase (Ordered Item) 38, the system accesses at least one preselected data table to check for a Value Item 40. In the preferred embodiment, the data table is contained within the client database. If a Value Item is not found, the system takes no further action 42 as to that Ordered Item.

If the system finds a Value Item, the system accesses at least one data table to determine whether designation as a Value Item is dependent upon a predetermined date range. The system determines whether the putative Value Item is being offered within the effective dates 44. If the putative Value Item falls outside the effective date range, the system takes no further action as to that Value Item 46.

If the system determines there is a Value Item to be offered (i.e. it is within the effective date range, or there is no limiting date range), the system then accesses at least one data table to determine whether the Value Item has been flagged by the user as a product the user does not want substituted (the process of which is described in greater detail below) 48. If the system determines the Value Item has been flagged, the system takes no further action as to that Value Item 50.

If the system determines the Value Item has not been flagged, the system accesses at least one data table to determine whether a Value Item that is produced by the same manufacturer of the Ordered Item, with only the brand name being different (secondary brand) is available 52. If a secondary brand is available, the system determined whether the user will accept a secondary brand 54. If the system determines the user will not accept a secondary brand, the system takes no further action as to that secondary brand 56. If the system determines the user will accept a secondary brand, the system advises the user that a Value Item is available (described in detail below) 62.

If the system determines the user will not accept a secondary brand, the system determines whether the Product Group has been designated by the user as one wherein the user would like to see a Value Item offered 58. If the system determines the user would not like to see a Value Item for the Product Group, the system takes no further action as to that Product Group 60.

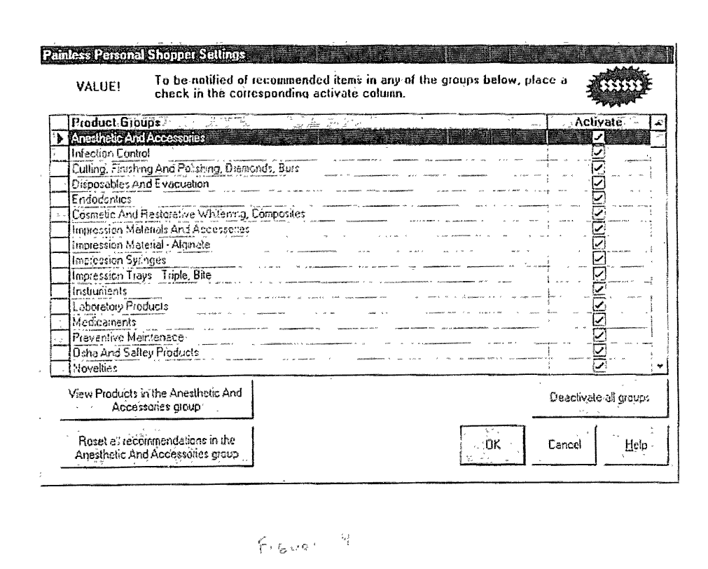

Also referring to FIG. 5, if the system determines the user would like to see a Value Item for the Product Group (Displayed Value Item), the system then displays a message, for example, through a pop-up window, indicating that there is a better Value Item available 62. Optionally, the system displays both the Ordered Item and the Displayed Value Item, the approximate savings obtained by choosing the Displayed Value Item, and an explanation why the substitution is a better value 64.

In determining the reported savings to the user, the system utilizes the following formula:

Savings %=1−((Value Item Price/Package Factor)/Original Price)

The Package Factor can best be defined by example: If product A comprises a package of quantity 10 selling for $12, and product B comprises a package of quantity 100 selling for $89, the package factor of product B will be 10, because there are ten times the quantity as package A.

The system obtains an explanation as to why the item is a better value from, for example, the Value Items table, as further described below, and presents that explanation to the user.

The system then presents the user with an option to accept the substitute Displayed Value Item 66. Upon input by the user, the system determines whether the user will accept substitution of the Displayed Value Item. If the system determines the user does not wish to substitute the Displayed Value Item, the system determines whether the user wishes the system to display the suggested Value Item in the future 68. After input from the user, if the system determines the user does not wish to see this suggested Value Item at the time of the next order, the system flags the item in at least one data table as one the user does not want to substitute 70. In a preferred embodiment, the system requires the user to affirmatively “opt out” of having the system display the suggested Value Item in the future.

Optionally, if the system determines that the user does not wish to substitute the Displayed Value Item 68, the system then determines whether the user wishes the system to display in the future any other suggested Value Items from the displayed Product Group 72. After input from the user, if the system determines the user does not wish to see any suggested Value Item from the Product Group, the system flags in at least one data table all Product Group items as ones the user does not want to substitute 74.

When the system determines that the Ordered Item has a Value Item substitute, the system calculates a suggested quantity based upon the quantity originally ordered and the package factor, and suggests a new quantity for the value item 76, which the user can modify upon placing an order.

After receiving input from the user, the system determines the dollar amount that the user has saved in selecting the Value Item over the Ordered Item, and reports the savings to the user 80, for example, by displaying the amounts saved on the user's computer terminal. Optionally, the system may also display the amount saved, for example, on a customer invoice, a report of preselected parameters prepared by the system, or any combination of the above. Preferably, the system also records to a user savings history data file the savings information for subsequent retrieval and tracking 82.

In determining the reported savings to the user, the system utilizes the following formula:

(Ordered Quantity*Package Factor*Ordered item Price)−(Ordered Quantity*Value Item Price)=Savings

For example, an Ordered Item is sold in a package of 5 and has associated with it a Value Item substitution sold in a package of 25 (equating to a package factor of 5). The Ordered Item price is $8, and the Value Item is priced at $35. If the original order is for 6 packages of 5, but 2 packages of the Value Item are substituted, the calculated savings would be (2*5*8)−(2*35)=$10.

If the system determines that the added value a Value Item offers is intangible, but with a negative savings, i.e. a higher, more durable quality, but at a slightly higher price (yielding a lower net cost for the Value Item's useful life over that of the Ordered Item), the product savings is not totaled using the above referenced formula.

When reporting the savings to the user, optionally, the system also presents to the user a savings explanation. The savings explanation is derived from a data table field linked to the value item, as further described below.

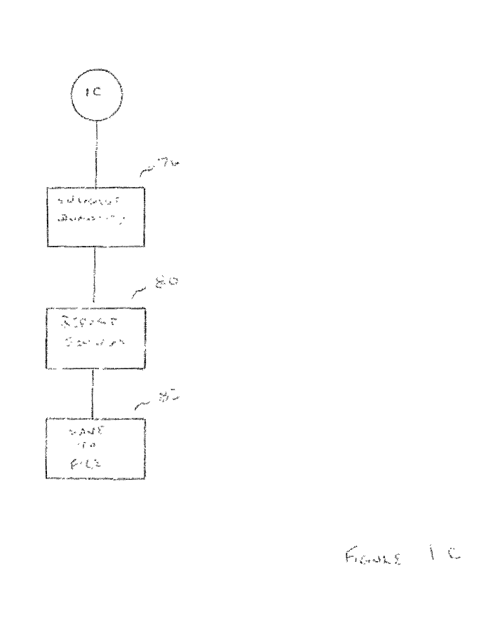

Referring to FIG. 2, the system categorizes within a database items for sale into predetermined Product Groupings 20. Within each Product Group, the system identifies similar products and specifies which product within the group has the best value 22. If a product has a date dependent time during which it is a Value Item, for example, a predetermined time period during which the product will be on sale, the system determines the effective dates as contained within the database 24.

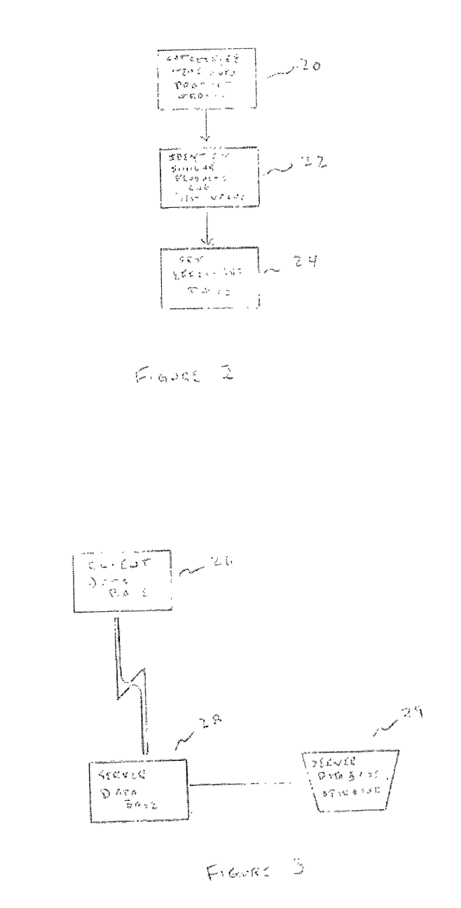

Referring to FIG. 3, the client database 26 is linked to an autonomous server database 28. Such linking may occur in real time or the linking may occur upon demand by the user, or upon a preselected event, for example, placement of an order by the system. As used herein, autonomous means not maintained by a third party, for example a manufacturer or vendor. Once linked data tables are transferred from the client database to the server database. Optionally, updates and/or upgrades to application programs residing on the client microprocessor platform may be implemented.

A server database operator 29 maintains, i.e. updates, the server database 28 on a predetermined schedule. Such a schedule may be based on a preselected time period such as daily, weekly, monthly, or quarterly, or it may be based on a specific triggering event, such as a pricing change by a manufacturer. Update to the server database 28 is performed manually, i.e. by a server database operator 29 entering changes into the server database by means of, for example a keyboard, or alternatively, the server database 28 may be updated via a real time link to a supplier or via a bulk “data dump” entered via a logic subroutine using a microprocessor. However, in all cases, the server database 28 is autonomous, therefore not susceptible to downtime due to corruption or other problems of third party databases.

The client database 26 links to the server database 28 as described above. The server database 28 may be located on an unlimited number of servers, or it may reside on a single server. Once linked, the system checks for new Product Groups added to the server database subsequent to the previous linking. As described above, the default is to not prompt for substitution within a Product Group, instead, requiring an affirmative opt in when new Product Groups are first added to the client database. However, the system does ask the user whether the system should display Value Items contained within the subsequently added Product Group.

The method and system of the present invention allows for an unlimited number of products. The number of products contained within the server database and subsequently, upon linking, the client database, determines how the data is maintained. Preferably, supervision of maintaining the currency of the server database should be the responsibility of a specified entity, for example, a marketing department.

The client database may reside on a micro processing device, for example, a personal computer, which uses an operating system format different from that wherein the server database resides. Therefore, in a preferred embodiment, to increase efficiency, a logic maintenance subroutine automatically gathers the data from the server database and converts the data into a format that can be transferred, i.e. downloaded, to the client database.

The logarithmic subroutine used to update the client database data fields is preferably a subroutine that will accept a table regardless of the number of fields contained within the table. In this manner, the subroutine can accommodate additional data fields that may be added, as required, to the database table. The data tables are linked to one another by programming methods well known to those skilled in the programming arts.

The following tables are exemplar of the data fields of the downloaded server database data.

TABLE 1
is an example of the data fields for Ordered Items.

| | | |
|---|---|---|
| Product Number | 20 Characters | This item can be substituted with |
| | | the Value Item (i.e. this is the |
| | | Ordered Item) (unique only within |
| | | effective dates of Value Item) |
| Value Item Key | Numeric | Link to the Value Item Table |
| Package Factor | Numeric | The number of Order Items that |
| | | equal (1) Value Item. Used to |
| | | calculate the savings, automatically |
| | | adjust order quantity, and enhance |
| | | the price comparison report. |
| Minimum Quantity | Numeric | Prevents suggested substitution |
| | | from occurring if the quantity |
| | | ordered is less than this number. |
| Prompt Flag | 1 Character | This flag may be set by user |
| | | interaction to system prompts and |
| | | contains the following flags: |
| | | “A” - auto substitute without |
| | | prompting (reserved for future use, |
| | | the user has no capability to switch |
| | | to this flag) |
| | | “N” - never prompt to substitute |
| | | this item |
| | | “ ” - default, always prompt to |
| | | substitute if all the other conditions |
| | | are met. |

TABLE 2
is an example of the data fields for Value Items.

| | | |
|---|---|---|
| Value Item Key | Numeric | Uniquely assigned sequentially, |
| | | Key to Value Item table (used to |
| | | link Ordered Items) |
| Value Item | 20 Characters | Product number of the Value Item |
| | | (unique only within effective dates) |
| Group Number | 10 Characters | Key to Product Groups table (can |
| | | be alphanumeric) |
| Explanation | Memo | Explanation will be presented to |
| | | the user explaining why the Value |
| | | Item is a value. Capitalization may |
| | | be used to emphasize. |
| Global Flag | 1 Character | Indicates if the item is a global |
| | | substitution. Value Item must be |
| | | an exact match to all Ordered |
| | | Items. |
| Start Date | Date | Inclusive starting date, no |
| | | prompting/substituting will occur |
| | | before this dtate. (internal only, |
| | | this will not display on any |
| | | dialogbox) |
| End Date | Date | Inclusive ending date, no |
| | | prompting/subbing will occur after |
| | | this date. (internal only, this will |
| | | not display on any dialogbox) |
| Price Override | Numeric | Optional, if present this price will |
| | | override all prices. |

TABLE 3
is an example of the data fields for Product Groups.

| | | |
|---|---|---|
| Group Number | 10 Characters | Key to Product Groups (can be |
| | | alphanumeric) (this is the default |
| | | sorting field) |
| Group Description | 50 Characters | Description of Group |
| Substitute Flag | 1 Character | Indicates whether the substitute |
| | | prompt should occur for items in |
| | | this group. Default is set to Don't |
| | | Prompt (client database only) |

Although not required for the system to function, in a preferred embodiment, the system does not link multiple Value Items to a single product. For example, as used in a dental supplier-dentist environment, silver crowns can only be substituted with the Value Item gold crowns. Platinum crowns would not be permitted to be the Value Item for silver crowns, regardless of the quantity factor. Furthermore, preferably, there is only one level of Value Items. For example, product “B” can be the Value Item for product “C”, but product “A” may not be the Value Item for product “B”.

The system separates products into predetermined Product Groups in order to enable the user to selectively disable the prompting of Value Items for preselected Ordered Items. In a preferred embodiment, Product Group names and product item contents are established by a preselected entity, for example, a marketing department. The entity responsible for identifying sales items used by the method and system of the present invention preferably coordinates with outside suppliers, for example, vendors and manufacturers, to reduce prices on product items so that they can be designated by the system as Value Items.

As discussed above, the system permits the user to select which Product Groups will be used in suggesting Value Items. In a preferred embodiment, the system presents to the user approximately thirty Product Groups, sorted by a system assigned group number. The Product Groups are logically organized, for example, by product lines with optional super and sub groupings. FIG. 4 is a screen shot of a representative listing of groups for a dentist—dental supplier transaction.

The system displays, for example, on a user's computer display, the available Product Groups, and permits the user to select the Product Groups for which the user would like the system to offer Value Items. Although not required for the system to function, in a preferred embodiment, by default, the system turns all Product Groups on, requiring the user to affirmatively opt out of a selected Product Group. Additionally, the system presents to the user an option to switch on or switch off all the Product Groups. The system also presents to the user the opportunity to review all the items that are contained within a preselected Product Group, for example, by displaying a “group detail” dialog. In this manner, if the user is brand-sensitive, i.e. not willing to substitute a Value Item supplied by a different manufacturer for that of the manufacturer of the Ordered Item, the user can opt out of having the system display Value Items from a manufacturer that is not the manufacturer of the Ordered Item.

Optionally, the system permits the user to display and/or print a report listing of, for example, the available Product Groups, the Product Group descriptions, and the user's current Value Item substitution acceptance setting for each Product Group. To prevent competitors from gaining and using proprietary information, the system will permit only preselected individuals, for example, employees and/or sales representatives to include individual products in a report. Such restrictions are administered, for example, through usage of a password or other known security measures.

Referring back to FIG. 5, as discussed above, when a user selects an Ordered Item, and that item has an entry in the Value Items table, the system alerts the user, for example by displaying a pop-up dialogbox, that a Value Item is available. The information presented by the system may include, for example, the Value Item product number, manufacturer, description, a reason or explanation as to why the item is a better value, or any combination thereof. The system then permits the user to accept or reject the Value Item, for example, by displaying on the user's display screen two buttons, one to accept the Value Item and one to keep the original Ordered Item.

When buttons are used, selection of the desired button should be intuitive, such that the user is able to easily determine which choice they are making. The system should not permit the user to bypass the selection process. For example, the system would disable the keyboard “Enter” button to prevent accidental by-passing. Optionally, the system can present to the user a link to the “group selection” window, so that the displayed Product Group can be disabled from further displaying Value Items.

The system enables the user to substitute a Value Item only when all of the following are satisfied: 1) the Product Group substitute flag has been set; 2) the quantity factor is reached; 3) if the current date is within the effective dates; and 4) the prompt flag is still blank, as further described below.

The system default choice will be to accept the better value substitute Value Item. The system allows a second key, for example, the <Esc> key to permit the user to keep the original Ordered Item.

Referring to FIG. 6, if the user accepts the Value Item substitute, the system preferably requires confirmation of the Value Item substitution, for example, through the use of a pop-up dialogbox. Preferably, the system also presents an option, for example, through the use of a check box at the bottom of the user's display screen, allowing the user to inform the system to no longer recommend the Value Item substitution, thereby setting the prompt flag.

Optionally, the system sets an internal flag invisible to the user, so that a preselected individual, for example, a system administrator, has the ability to track which items are being substituted and the frequency of any such substitution.

Optionally, the system can be configured to factor buy/get promotion items into suggested Value Items. As used herein, a buy/get promotion item is a product item wherein a purchase of quantity “x” entitles the user to an additional quantity “y” at no additional cost. Preferably, any buy/get information displayed by the system, for example, through the use of a pop-up dialogbox, occurs after the system provides the substitution prompt.

If special pricing for a better Value Item is available, for example a price override, the system displays this information so as to inform the user that the item is receiving special pricing. As used herein, a price override is a retail price different from the price charged for the identical item when not ordered using the system and method of the present invention, i.e. an order placed by telephone to an order entry individual. Generally, the price override is a smaller amount than that charged when ordering without the system or method of the present invention.

As discussed above, the system displays to the user, for example, through a pop-up dialogbox, a savings message, the content of which is dependant upon, for example, an order quantity, original price, substituted price, and package factor. If any such saving is negative in value, the system does not display a savings message.

If the system determines there is a Value Item to be offered, the system presents the user the opportunity to select preselected types of substitutions, for example, 1) global substitutions and 2) specified substitutions. In the preferred embodiment, on specific substitutions are used.

A global substitution is one wherein the Ordered Item and the Value Item are substantially the same, i.e. only the packaging name is different. When a user signifies they desire a global substitution, the system substitutes the Value Item only when available for delivery, and does not present the user an option to switch off the associated Product Group. Additionally, the system presents a global option preference to the user, wherein the user has the ability to switch on and to switch off the global replace. The system default is to have the global replace switched off.

Additionally, the system prompts the user, for example, through the use of a pop-up dialogbox, to select whether the system should 1) automatically substitute the item in the future without further prompting, or 2) not recommend the substitution again. Globally substituted Value Items preferably should have a one-to-one relationship to the Ordered Item, for example, if the Ordered Item is in a package of 5, the globally substituted Value Item preferably is also in a package of 5.

A specified substitution is one that is not global as defined above. In a specified substitution, the system suggests a Value Item substitution only in Product Groups wherein the user has indicated they wish to view items of better value.

After the user has completed the selection of all Ordered Items and Value Items, the system electronically transfers this information to the seller for order processing and delivery. This transfer may take place immediately upon conclusion of user item selection (real time) or it may take place at a subsequent time, either initiated automatically by a logic subroutine or initiated manually by the user, or it may occur during the linking process. The electronic transfer is accomplished by known connectivity means, such as a direct telephone connection, an Internet connection, a cellular network connection or a satellite connection.

Optionally, the system provides a help interface, for example, a pop-up help screen for real time answers to a user's question.

While not required, the system can utilize a preselected order template to increase re-ordering efficiency. For example, when the system determines from prior order history that a particular item is ordered on a repeating time interval, for example, monthly, the system will remind the user once each time interval of the need to reorder. Such reminder can be, for example, through the use of a pop-up reminder. If the user desires to reorder, the system displays the preselected order template for confirmation by the user.

The reports provided by the system may include, for example, such items as Value Items ordered and savings on purchases. The system allows for user selection of report variables. For example, the system can display total savings by order, by month, or by product. When a user selects a Value Item as the Ordered Item (i.e. the system did not have to prompt for substitution), optionally the system will also report the savings to the user by originally selecting the Value Item.

In a second preferred embodiment, the system resides at a location remote from the user. As used herein, residing remotely means that after linking with the server database, all functions are performed remote from the user's microprocessor, for example, the user's personal computer, with only the system responses displayed on the user's personal computer. Such a second preferred embodiment would be, for example, a web based embodiment. In this second preferred embodiment, a client database is optional. When a client database is not utilized, there would be no replication of data between the server and client.

Although the present invention has been described in connection with specific examples and embodiments, those skilled in the art will recognize that the present invention is capable of other variations and modifications within its scope. For example, the system may alert the user to better values when quantities are increased from the original Ordered Item quantity. For example, the system can be configured to alert a user that when a predetermined quantity threshold is exceeded, further savings may be obtained in ordering a “bulk” package. These examples and embodiments are intended as typical of, rather than in any way limiting on, the scope of the present invention as presented in the appended claims.

What is claimed is:

1. A method for the electronic offering and selection of substitute products of better value comprising the steps of:
electronically linking a client database to an autonomous server database for downloading preselected data tables from the server database to the client database;
inputting to the client database an Ordered Item for purchase;
searching the client database for a Value Item associated with the Ordered Item;
determining whether the associated Value Item is a Displayed Value Item; and
offering the associated Value Item in substitution for the Ordered Item when the Value Item is a Displayed Value Item.

2. A method for the electronic offering, selection and ordering of substitute products of better value comprising the steps of:
electronically linking a client database to an autonomous server database for downloading preselected data tables from the server database to the client database;
inputting to the client database an Ordered Item for purchase;
searching the client database for a Value Item associated with the Ordered Item;
determining whether the associated Value Item is a Displayed Value Item;
offering the associated Value Item in substitution for the Ordered Item when the Value Item is a Displayed Value Item; and
electronically transmitting a purchase order comprising at least one item selected from the group consisting of an Ordered Item and a Value Item.

3. The method of claim 2 wherein the step of inputting to the client database is accomplished via a local input/output device.

4. The method of claim 2 wherein the client database is contained within a local personal computer.

5. The method of claim 2 wherein the step of electronically linking is accomplished through an electronic connection selected from the group consisting of a telephone connection and the worldwide web.

6. The method of claim 2 further comprising the steps of 1) displaying to a user at least one preselected Product Group and 2) allowing the user to selectively determine whether a Value Item is to be offered for an Ordered Item contained within the at least one preselected Product Group.

7. The method of claim 6 wherein the at least one preselected Product Group comprises products of predetermined similarities.

8. The method of claim 6 wherein the at least one preselected Product Group is displayed via a format selected from the group consisting of a pull down menu, a pop-up menu and a separate screen.

9. The method of claim 6 further comprising the step of determining whether the Offered Item is contained within a preselected Product Group that has been selected to allow substitution of a Value Item.

10. The method of claim 6 further comprising the steps of 1) allowing a user to determine whether any Value Item associated with Ordered Items contained within a preselected Product Group is to be displayed at future orders and 2) determining whether the Ordered Item has is contained within a Product Group that allows for substitution of a Value Item.

11. The method of claim 2 further comprising the steps of 1) allowing a user to selectively allow a secondary brand to qualify as a Displayed Value Item and 2) determining whether the secondary brand has been selected by the user to qualify as a Displayed Value Item.

12. The method of claim 2 wherein the step of determining whether the associated Value Item is a Displayed Value Item further comprises the step of determining whether the Value Item is falls within a predetermined Value Item allowable date range.

13. The method of claim 2 further comprising the steps of 1) allowing a user to selectively flag a Value Item to not be offered for substitution and 2) determining whether the Value Item has been flagged as a product not to be substituted.

14. The method of claim 2 wherein the step of offering the associated Value Item in substitution for the Ordered Item further includes the step of displaying a message comprising at least one display selected from the group consisting of the Ordered Item, the Value Item, the approximate savings, and an explanation as to why the Value Item is a better value.

15. The method of claim 2 wherein the step of offering the associated Value Item in substitution for the Ordered Item further includes the step of calculating and displaying a suggested quantity for achieving greater value based upon an originally ordered quantity and a package factor.

16. The method of claim 14 wherein the approximate savings is calculated by the formula: Savings %=1−((Value Item Price/Package Factor)/Original Price).

17. The method of claim 2 further comprising the steps of 1) allowing a user to selectively determine whether the Displayed Value Item is to be displayed at future orders and 2) whether the Value Item has been selected to be displayed at future orders.

18. The method of claim 2 wherein the step of electronically transmitting a purchase order further includes the step of determining and displaying an amount saved in selecting the Value Item.

19. The method of claim 18 wherein the amount saved is calculated by the formula: (Ordered Quantity*Package Factor*Ordered item Price)−(Ordered Quantity*Value Item Price)=Savings.

20. The method of claim 18 wherein the amount saved is displayed on at least one display selected from the group consisting of a video display terminal, a customer invoice, and a report of user selected preselected parameters.

21. The method of claim 18 further comprising the step of recording to a user savings history file the amount saved.

22. The method of claim 2 wherein the step of electronically linking a client database to an autonomous server database further comprises the step of updating a local application program.

23. The method of claim 2 wherein the step of electronic linking occurs on a predetermined schedule.

24. The method of claim 2 wherein the step of electronic linking is achieved by a method selected from the group consisting of manual linking and automated linking.

25. The method of claim 2 wherein the step of electronically linking a client database to an autonomous server database further includes the step of checking for a new Product Group added to the server database subsequent to a previous linking.

26. The method of claim 2 further comprising the step of allowing a user to selectively determine whether a Value Item should be a Displayed Value Item.

27. The method of claim 2 further comprising the step of automatically gathering via a logic subroutine data from the server database and converting the data into a format capable of being transferred to the client database upon linking.

28. The method of claim 2 wherein the Value item is associated with only a single Ordered Item.

29. The method of claim 2 further comprising the step of tracking which Ordered Items are being substituted and the frequency of any such substitution.

30. The method of claim 2 further comprising the step of permitting a user to reversibly choose a Value Item substitution method selected from the group consisting of global substitutions and specified substitutions.

31. The method of claim 2 wherein the step of electronically transmitting the purchase order occurs at a time selected from the group consisting of real time transmission, logic subroutine controlled transmission, manual transmission and linking associated transmission.

32. The method of claim 2 further comprising the step of providing a help interface upon request from a user.

33. The method of claim 2 further comprising the step of providing a preselected order template for increasing re-ordering efficiency.

34. The method of claim 2 further comprising the steps of 1) determining whether increased value is obtainable by substitution of bulk quantity and 2) informing a user of the increased value.

35. A system for the electronic offering, selection and ordering of substitute products of better value comprising:
a client database for storing data, the data comprising preselected user parameters and preselected data tables downloaded from an autonomous server database;
the autonomous server database comprising preselected data tables;
an electronic interface for downloading at least one of the preselected data tables from the server database to the client database;
an input collection system for obtaining user inputted information;
a data access system for determining the availability of a Displayed Value Item associated with a user inputted Ordered Item;
a display system for presenting to a user the Displayed Value Item; and
an ordering system for electronically transmitting a purchase order, the purchase order comprising at least one product selected from the group consisting of Ordered Items and Value Items.

36. The system of claim 35 wherein the client database is located on a local personal computer.

37. The system of claim 35 wherein the data tables comprise preselected information for associating the Ordered Item to a Value Item.

38. The system of claim 35 wherein the electronic interface is an electronic link selected from the group consisting of a telephone connection and the world wide web.

39. The system of claim 35 wherein the input collection system is a local input/output device.

40. The system of claim 35 wherein the user inputted information is information used by the system to determine whether a Value Item is also a Displayed Value Item.

41. The system of claim 40 wherein the information used by the system is at least one parameter chosen by a user based upon at least one system function selected from the group consisting of Product Groups, future orders, secondary brand, predetermined Value Item allowable date range, and Value Item selectivity flag.

42. The system of claim 35 wherein the data access system determines the availability of a Displayed Value Item based upon at least one parameter chosen by a user based upon at least one system function selected from the group consisting of Product Groups, future orders, secondary brand, predetermined Value Item allowable date range, and Value Item selectivity flag.

43. The system of claim 35 wherein the display system comprises at least one display selected from the group consisting of a video display terminal, a customer invoice, and a report of user selected preselected parameters.

44. The system of claim 35 wherein the display system further presents to the user at least one item selected from the group consisting of the Ordered Item, the Value Item, the approximate savings, and an explanation as to why Value Item is a better value.

45. A method for the electronic offering, selection and ordering of substitute products of better value comprising the steps of:
electronically interfacing a remotely located autonomous database with a user input/display device;
inputting into the input/display device an Ordered Item for purchase;
searching the database for a Value Item associated with the Ordered Item;
determining whether the associated Value Item is a Displayed Value Item;
offering through the input/display device the associated Value Item in substitution for the Ordered Item when the Value Item is a Displayed Value Item; and
electronically transmitting through the interface a purchase order comprising at least one item selected from the group consisting of an Ordered Item and a Value Item.

46. The method of claim 45 wherein the step of electronically interfacing a remotely located autonomous database with a user input/display device is accomplished with a web based interface.

47. The method of claim 46 wherein the web based interface is the Internet.
